(19) United States
(12) Patent Application Publication
(10) Pub. No.: US 2023/0259011 A1
(43) Pub. Date: Aug. 17, 2023

(54) PROJECTION APPARATUS

(71) Applicant: IVIEW DISPLAYS (SHENZHEN) COMPANY LTD., Shenzhen (CN)

(72) Inventors: Guoming Lu, Shenzhen (CN); Mingnei Ding, Shenzhen (CN); Wenxiang Li, Shenzhen (CN); Steve Yeung, Hongkong (CN); Zhiqiang Gao, Hongkong (CN)

(21) Appl. No.: 18/305,450

(22) Filed: Apr. 24, 2023

Related U.S. Application Data
(63) Continuation of application No. PCT/CN2021/100653, filed on Jun. 17, 2021.

(30) Foreign Application Priority Data
Apr. 7, 2021 (CN) 202110374126.5

(51) Int. Cl. G03B 21/14; G03B 21/28

(52) U.S. Cl. CPC G03B 21/142; G03B 21/28

(57) ABSTRACT

Embodiments of the present application relate to a projection apparatus. The projection apparatus includes: a projection apparatus body; a projection unit, disposed on the projection apparatus body, and configured to project a projection picture; and an adjustment unit, disposed on the projection apparatus body and being movable relative to the projection apparatus body, wherein in response to moving to a first position relative to the projection apparatus body, the adjustment unit is configured to bear exit light from the projection unit, and adjust a projection direction of the exit light. The adjustment unit bears exit light from the projection unit and adjusts the projection direction of the exit light, such that a projection direction of the projection picture is adjusted.

### CROSS-REFERENCE TO RELATED APPLICATIONS

This application is a continuation-application of International (PCT) Patent Application No. PCT/CN2021/100653, filed on Jun. 17, 2021, which claims priority to Chinese Patent Application No. 202110374126.5, filed with the National Intellectual Property Administration of China on Apr. 7, 2021, and entitled “PROJECTION APPARATUS”, the entire contents of which are incorporated herein by reference.

### TECHNICAL FIELD

Embodiments of the present disclosure relate to the field of display technologies.

### BACKGROUND

A projection apparatus is an optical instrument which magnifies, by using an optical element, a picture to be projected, such as an image, a video, or a 3D animation, and projects the magnified picture to be projected onto a screen or a wall. Some projection apparatuses may be connected to a computer, a VCD, a DVD, a BD, a game machine, a DV, and the like via different interfaces to play corresponding video signals. Some other projection apparatuses may be connected to a WiPlug, then a computer, a mobile phone, or a pad is connected to the WiPlug within a same Wi-Fi network, and finally content of the computer, the mobile phone or the pad may be synchronously displayed onto the screens of the projection apparatuses. Therefore, the projection apparatus is widely used in home theaters, automobile head-up displays, medical equipment assistances, and the like.

During the practice of the present disclosure, the present inventors have found that: at present, the projection apparatus at the market is inconvenient to adjust a projection direction of a projection picture, and needs to be moved as a whole for adjusting the projection direction of the projection picture, such that user experience is poor.

### SUMMARY

According to an embodiment of the present disclosure, a projection apparatus is provided. The projection apparatus includes: a projection apparatus body; a projection unit, disposed on the projection apparatus body, and configured to project a projection picture; and an adjustment unit, disposed on the projection apparatus body and being movable relative to the projection apparatus body, wherein in response to the adjustment unit moving to a first position relative to the projection apparatus body, the adjustment unit is configured to bear exit light from the projection unit, and adjust a projection direction of the exit light.

According to another embodiment of the present disclosure, a projection apparatus is provided. The projection apparatus includes: a projection apparatus body; a projection unit, connected to the projection apparatus body, and configured to project a projection picture; and, an adjustment unit, connected to the projection apparatus body and being movable relative to the projection apparatus body; wherein in response to the adjustment unit moving to a first position relative to the projection apparatus body, the adjustment unit is configured to receive exit light from the projection unit, and adjust a projection direction of the exit light; wherein in response to the adjustment unit moving to a second position relative to the projection apparatus body, the adjustment unit is received in the projection apparatus body.

According to another embodiment of the present disclosure, a projection apparatus is provided. The projection apparatus includes: a projection apparatus body; a projection unit, connected to the projection apparatus body, and configured to project a projection picture; and, an adjustment unit, connected to the projection apparatus body and being movable relative to the projection apparatus body; wherein in response to the adjustment unit partially moving out of the projection apparatus body, the adjustment unit is configured to receive exit light from the projection unit, and adjust a projection direction of the exit light; wherein the adjustment unit is further configured to move to be received in the projection apparatus body.

### BRIEF DESCRIPTION OF THE DRAWINGS

One or more embodiments are illustrated by way of example, and not by limitation, in the accompanying drawings, wherein components having the same reference numeral designations represent like components throughout. The drawings are not to scale, unless otherwise disclosed.

FIG. 1 is a schematic diagram illustrating a practice of a projection apparatus according to an embodiment of the present disclosure.

FIG. 2 is a schematic diagram of a projection apparatus body according to an embodiment of the present disclosure.

FIG. 3 is a schematic diagram illustrating practice of an adjustment unit and a drive unit according to an embodiment of the present disclosure.

FIG. 4 is a schematic diagram illustrating connections between some elements in the projection apparatus according to an embodiment of the present disclosure.

FIG. 5 is a schematic sectional diagram of the projection apparatus according to an embodiment of the present disclosure.

FIG. 6 is a schematic diagram illustrating another practice of the projection apparatus according to an embodiment of the present disclosure.

### DETAILED DESCRIPTION

For better understanding of the present disclosure, the present disclosure is described in detail with reference to attached drawings and specific embodiments. It should be noted that, when an element is defined as “being secured or fixed to” another element, the element may be directly positioned on the element or one or more centered elements may be present therebetween. When an element is defined as “being connected or coupled to” another element, the element may be directly connected or coupled to the element or one or more centered elements may be present therebetween. As used herein, the terms “vertical,” “horizontal,” “left,” “right,” “inner,” “outer,” and similar expressions are only for illustration purposes.

Unless the context clearly requires otherwise, throughout the specification and the claims, technical and scientific terms used herein denote the meaning as commonly understood by a person skilled in the art. Additionally, the terms used in the specification of the present disclosure are merely for describing the objects of the specific embodiments, and are not intended to limit the present disclosure. As used herein, the term “and/or” in reference to a list of one or more items covers all of the following interpretations of the term: any of the items in the list, all of the items in the list and any combination of the items in the list.

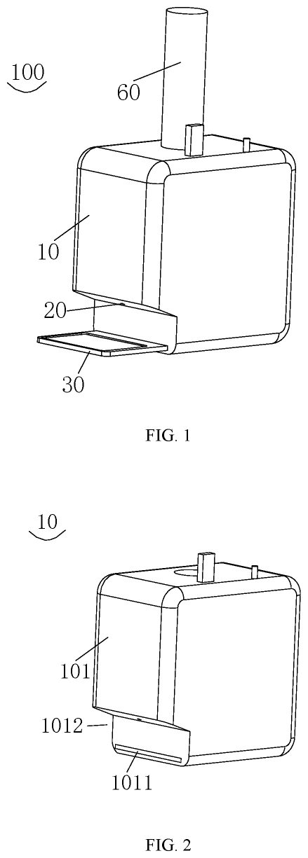

Referring to FIG. 1, a projection apparatus 100 includes: a projection apparatus body 10, a projection unit 20, and an adjustment unit 30. The projection unit 20 and the adjustment unit 30 are both disposed on the projection apparatus body 10, and the projection unit 20 is configured to project a projection picture. The adjustment unit 30 is movable relative to the projection apparatus body 10, and in response to the adjustment unit moving to a first position relative to the projection apparatus body 10, the adjustment unit 30 is configured to bear exit light from the projection unit 20, and adjust a projection direction of the exit light. The adjustment unit 30 bears the exit light from the projection unit 20 and adjusts the projection direction of the exit light, such that a projection direction of the projection picture is adjusted. In this way, the adjustment may be practiced with no need of moving the projection apparatus 100, and thus the operation is convenient.

It should be noted that, in response to the adjustment unit 30 moving to the first position relative to the projection apparatus body 10, the adjustment unit 30 bears the exit light from the projection unit 20, and adjusts the projection direction of the exit light.

With respect to the projection apparatus body 10, referring to FIG. 1 and FIG. 2, in some embodiments, the projection apparatus body 10 includes a housing 101, wherein the housing 101 is provided with a receiving chamber and a through hole 1011 in communication with the receiving chamber. Via the through hole 1011, the adjustment unit 30 enters or leaves from the receiving chamber of the housing 101.

It should be noted that, in some embodiments, the housing 101 is recessed to form a recess 1012, and the through hole 1011 is positioned at a bottom of the recess 1012. The exit light from the projection unit 20 is projected from a wall of the recess 1012, and in response to the adjustment unit 30 leaving from the receiving chamber via the through hole 1011 and moving to the first position, the adjustment unit 30 bears the exit light from the projection unit 20, and is at least partially positioned in the recess 1012, such that the adjustment unit 30 is not easily damaged, and an overall structure of the projection apparatus 100 is compact.

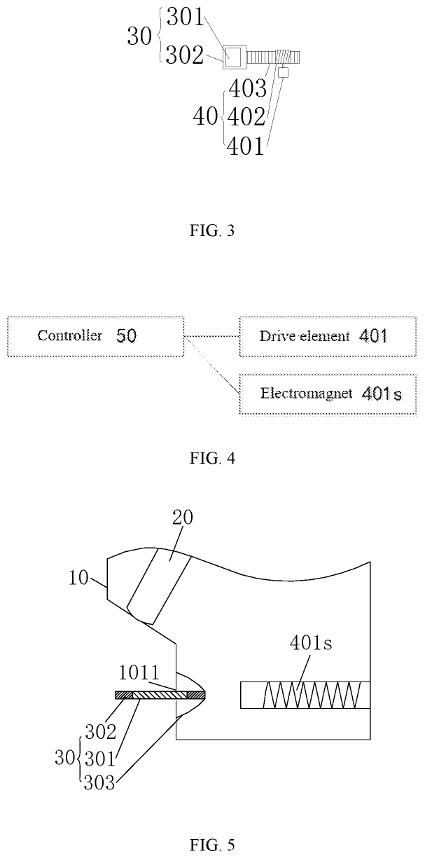

With respect to the adjustment unit 30, referring to FIG. 1 and FIG. 3, in some embodiments, the adjustment unit 30 includes a light adjustment element 301 and a support element 302, wherein the light adjustment element 301 is connected to the support element 302, and the light adjustment element 301 is configured to bear the exit light from the projection unit 20 and adjust the projection direction of the exit light, and the support element 302 is connected to the light adjustment element 301 and configured to support the light adjustment element 301.

It should be noted that, in some embodiments, the light adjustment element 301 includes a mirror, wherein the mirror is configured to bear the exit light from the projection unit 20, and reflect the exit light to adjust the projection direction of the exit light. For example, the projection picture projected by projection unit 20 is positioned on the ground, and in response to the adjustment unit 30 moving to the first position relative to the projection apparatus body 10, the exit light from the projection unit 20 is reflected, and the projection direction of the exit light is adjusted, such that the projection picture projected by projection unit 20 is adjusted to a ceiling.

It should be noted that, in some embodiments, the light adjustment element 301 includes a combination of a plurality of mirrors, such that the projection direction of the exit light from the projection unit 20 is adjusted in multiple directions.

It may be understood that, in some embodiments, the light adjustment element 301 may not include the mirror, but include other types of prisms.

It should be noted that, when the adjustment unit 30 includes the light adjustment element 301 and the support element 302, and in response to the adjustment unit 30 moving to the first position relative to the projection apparatus body 10, the adjustment unit 30 bears the exit light from the projection unit 20, and the exit light from the projection unit 20 is projected on a center of the light adjustment element 301.

It should be noted that the adjustment unit 30 may be manually or mechanically pushed to enter or leave from the receiving chamber. In response to the adjustment unit 30 entering or leaving from the receiving chamber in a mechanical driving fashion, the projection apparatus 100 further includes a drive unit 40 and a controller 50. The drive unit 40 is connected to the adjustment unit 30 and the controller 50. The controller 50 is configured to control the drive unit 40 to push the adjustment unit 30 from the receiving chamber to the first position. The controller 50 is further configured to control the drive unit 40 to move the adjustment unit 30 to the receiving chamber.

With respect to the drive unit 40, referring to FIG. 3 and FIG. 4, in some embodiments, the drive unit 40 includes a drive element 401, a gear 402, and a rack 403. The drive element 401 is connected to the gear 402 and the controller 50, the controller 50 is configured to control the drive element 401 to drive the gear 402 to rotate, the gear 402 is meshed with the rack 403, the rack 403 is connected to the adjustment unit 30, and the rack 403 is movable relative to the housing 101, and drives the adjustment unit 30 to enter or leave from the receiving chamber via the through hole 1011 in response to the drive element 401 driving the gear 402 to rotate.

It should be noted that, when the adjustment unit 30 includes the light adjustment element 301 and the support element 302, the rack 403 is connected to the support element 302.

It should be noted that, in some embodiments, the drive unit 401 includes a motor.

It should be understood that, in some embodiments, the rack 403 and the support element 302 are integrally formed.

With respect to the drive unit 40, in some embodiments, referring to FIG. 4 and FIG. 5, the drive unit 40 includes an electromagnet 401s, wherein the electromagnet 401s is connected to the controller 50, and the controller 50 is configured to control the electromagnet 401s to be magnetized to attract the support element 302, such that the adjustment unit 30 enters the receiving chamber via the through hole 1011. The adjustment unit 30 further includes an elastic element 303, wherein one end of the elastic element 303 is connected to the housing 101, and the other end of the elastic element 303 is connected to an end, proximal to the drive unit 40, of the support element 302. The elastic element 303 generates an elastic force in response to the electromagnet 401s attracting the support element 302, and the support element 302 is pushed by the elastic element 303 out of the receiving chamber in response to the controller 50 controlling the electromagnet 401s to be demagnetized.

It should be noted that, in some embodiments, the number of the elastic elements 303 is two, and the other ends of the two elastic elements 303 are oppositely disposed on two sides of the support element, such that the support element 302 is stably pushed by the elastic force of the elastic element 303 out of the receiving chamber.

It should be noted that, in some embodiments, the elastic element 303 includes an elastic sheet.

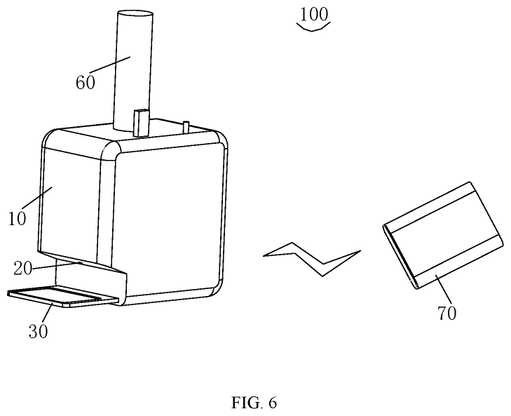

Referring to FIG. 6, in some embodiments, the projection apparatus 100 further includes a telescopic unit 60, wherein one end of the telescopic unit 60 is connected to the projection apparatus body 10, the other end of the telescopic unit 60 is configured to be fixed to an external object. By configuration of the telescopic unit 60, in one aspect, the projection apparatus 100 may be connected to the external object, for example, the ceiling; in another aspect, the distance between the projection apparatus body 10 and the external object may be adjusted via the telescopic unit 60.

It should be noted that, in some embodiments, the telescopic unit 60 may be further connected to the controller 50, and the controller 50 is configured to control the telescopic unit 60 to adjust the distance between the projection apparatus body 10 and the external object. The solution that the telescopic unit 60 adjusts the distance between the projection apparatus body 10 and the external object is the related art, which is not detailed herein any further.

Referring to FIG. 6, in some embodiments, the projection apparatus 100 further includes a display unit 70 and a communication unit (not illustrated). The display unit 70 is connected to the controller 50 in the projection apparatus 100 via the communication unit, and configured to display a plurality of projection pictures to be projected for the selection of a user, and the projection unit 20 projects the projection picture selected by the user.

It should be noted that program steps involved in the controller 50 employ conventional program steps. The controller 50 may also employ a convention processor, for example, an Intel I3 processor, an AMD Ryzen processor, or the like.

In the embodiments of the present disclosure, the projection apparatus 100 includes: the projection apparatus body 10, the projection unit 20, and the adjustment unit 30. The projection unit 20 and the adjustment unit 30 are both disposed in the projection apparatus body 10, and the projection unit 20 is configured to project a projection picture. The adjustment unit 30 is movable relative to the projection apparatus body 10, and in response to the adjustment unit 30 moving to a first position relative to the projection apparatus body 10, the adjustment unit 30 is configured to bear exit light from the projection unit 20, and adjust a projection direction of the exit light. By configuration of the adjustment unit 30 in the projection apparatus, the adjustment unit 30 bears the exit light from the projection unit 20 and adjusts the projection direction of the exit light, such that a projection direction of the projection picture is adjusted. In this way, the adjustment may be practiced with no need of moving the projection apparatus 100, and thus the operation is convenient.

It should be noted that, the specification and drawings of the present disclosure illustrate preferred embodiments of the present disclosure. However, the present disclosure may be implemented in different manners, and is not limited to the embodiments described in the specification. The embodiments described are not intended to limit the present disclosure, but are directed to rendering a thorough and comprehensive understanding of the disclosure of the present disclosure. In addition, the above described technical features may incorporate and combine with each other to derive various embodiments not illustrated in the above specification, and such derived embodiments shall all be deemed as falling within the scope of the specification of the present disclosure. Further, a person skilled in the art may make improvements or variations according to the above description, and such improvements or variations shall all fall within the protection scope as defined by the claims of the present disclosure.

1. A projection apparatus, comprising:
a projection apparatus body;
a projection unit, disposed on the projection apparatus body, and configured to project a projection picture; and
an adjustment unit, disposed on the projection apparatus body and being movable relative to the projection apparatus body; wherein in response to the adjustment unit moving to a first position relative to the projection apparatus body, the adjustment unit is configured to bear exit light from the projection unit, and adjust a projection direction of the exit light.

2. The projection apparatus according to claim 1, wherein
the projection apparatus body comprises a housing, wherein the housing is provided with a receiving chamber and a through hole in communication with the receiving chamber;
the adjustment unit is received in the receiving chamber via the through hole, and is movable relative to the housing; and
in response to the adjustment unit leaving from the receiving chamber via the through hole, and moving to the first position, the adjustment unit bears the exit light from the projection unit, and adjusts the projection direction of the exit light.

3. The projection apparatus according to claim 2, wherein the adjustment unit comprises a light adjustment element and a support element, the light adjustment element is connected to the support element, the light adjustment element is configured to bear the exit light from the projection unit and adjust the projection direction of the exit light, and the support element is connected to the light adjustment element and configured to support the light adjustment element.

4. The projection apparatus according to claim 3, wherein the light adjustment element comprises a mirror, wherein the mirror is configured to bear the exit light from the projection unit, and reflect the exit light to adjust the projection direction of the exit light.

5. The projection apparatus according to claim 4, further comprising: a drive unit and a controller;
wherein the drive unit is connected to the adjustment unit and the controller, and the controller is configured to control the drive unit to push the adjustment unit from the receiving chamber to the first position.

6. The projection apparatus according to claim 3, further comprising: a drive unit and a controller;
wherein the drive unit is connected to the adjustment unit and the controller, and the controller is configured to control the drive unit to push the adjustment unit from the receiving chamber to the first position.

7. The projection apparatus according to claim 6, wherein the drive unit comprises a drive element, a gear, and a rack, the drive element is connected to the gear and the controller, the controller is configured to control the drive element to drive the gear to rotate, the gear is meshed with the rack, the rack is connected to the adjustment unit, and the adjustment unit enters or leaves from the receiving chamber via the through hole in response to the drive element driving the gear to rotate.

8. The projection apparatus according to claim 6, wherein
the drive unit comprises an electromagnet, wherein the electromagnet is connected to the controller, and the controller is configured to control the electromagnet to be magnetized to attract the support element, such that the adjustment unit enters the receiving chamber via the through hole;
the adjustment unit further comprises an elastic element, wherein one end of the elastic element is connected to the housing, and the other end of the elastic element is connected to an end, proximal to the drive unit, of the support element; and
the elastic element generates an elastic force in response to the electromagnet attracting the support element, and the support element is pushed by the elastic element out of the receiving chamber in response to the controller controlling the electromagnet to be demagnetized.

9. The projection apparatus according to claim 8, wherein the number of the elastic elements is two, and the other ends of the two elastic elements are oppositely disposed on two sides of the support element.

10. The projection apparatus according to claim 7, wherein the elastic element comprises an elastic sheet.

11. The projection apparatus according to claim 9, wherein the elastic element comprises an elastic sheet.

12. The projection apparatus according to claim 1, further comprising a telescopic unit, wherein one end of the telescopic unit is connected to the projection apparatus body, the other end of the telescopic unit is configured to be fixed to an external object, and the telescopic unit is configured to adjust a distance between the projection apparatus body and the external object.

13. The projection apparatus according to claim 2, wherein the light adjustment element comprises a mirror, wherein the mirror is configured to bear the exit light from the projection unit, and reflect the exit light to adjust the projection direction of the exit light.

14. A projection apparatus, comprising:
a projection apparatus body;
a projection unit, connected to the projection apparatus body, and configured to project a projection picture; and
an adjustment unit, connected to the projection apparatus body and being movable relative to the projection apparatus body; wherein in response to the adjustment unit moving to a first position relative to the projection apparatus body, the adjustment unit is configured to receive exit light from the projection unit, and adjust a projection direction of the exit light; wherein in response to the adjustment unit moving to a second position relative to the projection apparatus body, the adjustment unit is received in the projection apparatus body.

15. The projection apparatus according to claim 14, wherein
the projection apparatus body comprises a housing, wherein the housing is provided with a receiving chamber and a through hole in communication with the receiving chamber;
the adjustment unit is able to be received in the receiving chamber via the through hole, and is movable relative to the housing; and
in response to the adjustment unit leaving from the receiving chamber via the through hole, and moving to the first position, the adjustment unit bears the exit light from the projection unit, and adjusts the projection direction of the exit light.

16. A projection apparatus, comprising:
a projection apparatus body;
a projection unit, connected to the projection apparatus body, and configured to project a projection picture; and
an adjustment unit, connected to the projection apparatus body and being movable relative to the projection apparatus body; wherein in response to the adjustment unit partially moving out of the projection apparatus body, the adjustment unit is configured to receive exit light from the projection unit, and adjust a projection direction of the exit light; wherein the adjustment unit is further configured to move to be received in the projection apparatus body.
